(19) United States
(12) Patent Application Publication
(10) Pub. No.: US 2008/0121069 A1
(43) Pub. Date: May 29, 2008

(54) Rear cover assembly for automatic transmission

(76) Inventor: Hong Seok Yang, Hwaseong-city (KR)

Correspondence Address: MORGAN, LEWIS & BOCKIUS LLP (SF), One Market, Spear Street Tower, Suite 2800, San Francisco, CA, 94105, US

(21) Appl. No.: 11/590,989

(22) Filed: Nov. 1, 2006

(30) Foreign Application Priority Data
Jun. 23, 2006 (KR) 10-2006-0056884

(51) Int. Cl. F16H 57/00

(52) U.S. Cl. 74/606 R

(57) ABSTRACT

A rear cover assembly for a drive shaft of an automatic transmission includes a rear cover to which a bearing for supporting the drive shaft is disposed, an elliptical sleeve secured to the rear cover, and a seal ring disposed to the sleeve. The ratio between the major axis and the minor axis of the sleeve may be 21 to 20. The sleeve may be secured to the rear cover by being pressed thereon.

### CROSS-REFERENCE TO RELATED APPLICATION

This application claims priority to and the benefit of Korean Patent Application No. 10-2006-0056884 filed in the Korean Intellectual Property Office on Jun. 23, 2006, the entire contents of which are incorporated herein by reference.

### BACKGROUND OF THE INVENTION

(a) Field of the Invention

The present invention relates to a rear cover assembly of an automatic transmission. More particularly, the present invention relates to a rear cover assembly made by a reduced manufacturing process.

(b) Description of the Related Art

Generally, a rear cover assembly of an automatic transmission supports the drive shaft at a rear portion of the automatic transmission.

A conventional rear cover assembly includes a sleeve disposed between a seal ring and a rear cover or between the seal ring and a retainer. In order to prevent the rotation of the sleeve, a calking portion is formed. Because a groove is formed on the sleeve and a portion of the rear cover is inserted to the groove, the manufacturing process is complicated and the manufacturing time is increased.

The above information disclosed in this Background section is only for enhancement of understanding of the background of the invention and therefore it may contain information that does not form the prior art that is already known in this country to a person of ordinary skill in the art.

### SUMMARY OF THE INVENTION

An exemplary embodiment of the present invention provides a rear cover assembly supporting a drive shaft of an automatic transmission including a rear cover to which a bearing supporting the drive shaft is disposed, an elliptical sleeve secured to the rear cover, and a seal ring disposed to the sleeve. The ratio between the major and minor axes of the sleeve may be 21 to 20. The sleeve may be secured to the rear cover by being pressed therein.

### BRIEF DESCRIPTION OF THE DRAWINGS

FIG. 1 is a perspective view of a rear cover assembly of an automatic transmission according to an exemplary embodiment of the present invention.

FIG. 2 is a top view of a rear cover assembly of an automatic transmission according to an exemplary embodiment of the present invention.

FIG. 3 is a top view of a sleeve of a rear cover assembly of an automatic transmission according to an exemplary embodiment of the present invention.

### DETAILED DESCRIPTION OF THE PREFERRED EMBODIMENTS

An exemplary embodiment of the present invention will hereinafter be described in detail with reference to the accompanying drawings.

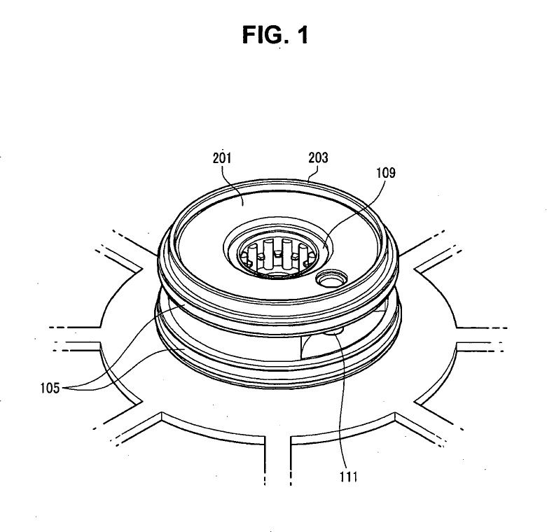

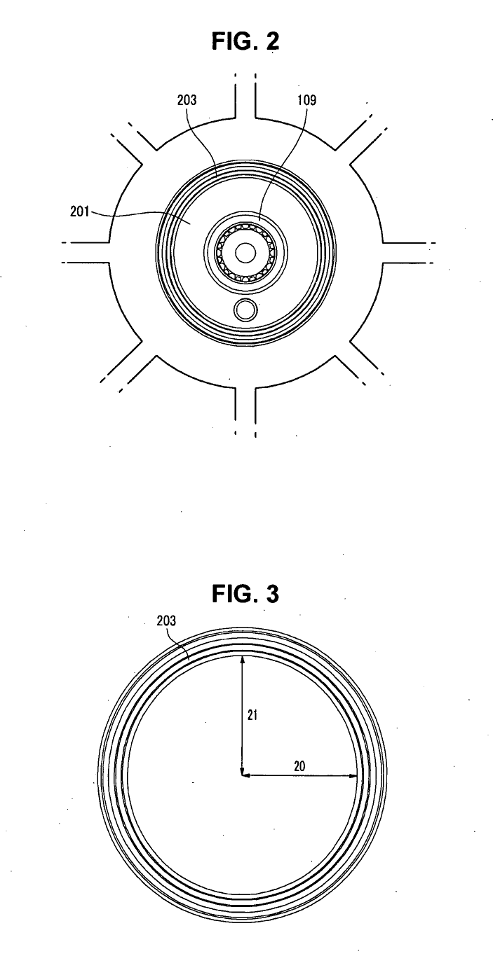

Referring to FIG. 1 and FIG. 2, according to an exemplary embodiment of the present invention, a rear cover assembly includes a rear cover 201, a sleeve 203, and a seal ring 105.

A bearing 109 supporting the drive shaft is disposed to the rear cover 201. The drive shaft (not shown) that receives power from an engine (not shown) is disposed to the automatic transmission, and one end of the drive shaft is supported by the bearing 109 according to an exemplary embodiment of the present invention.

The sleeve 203 is elliptical, and is secured to the rear cover 201. (While the general literal definition of an ellipse includes circles, in this specification, the definition of an ellipse should be understood not to include circles.)

The seal ring 105 is disposed to the sleeve 203 such that oil utilized in operation of the automatic transmission does not leak.

The sleeve 203 may be disposed between the retainer (not shown) and the seal ring 105, or between the seal ring 105 and the rear cover 201, such that the retainer, the seal ring 105, and the rear cover 201 are not abraded.

Referring to FIG. 1, if the sleeve 203 were to rotate, a hydraulic line 111 would be intercepted, and operation of the automatic transmission would stop. That is, if the sleeve 203 were to rotate, a speed shift could not be attained.

Because the sleeve 203 is elliptical, the sleeve 203 is secured to the rear cover 201 and does not rotate around the rear cover 201. Therefore, a process to manufacture the sleeve 203 and the rear cover 201 can be simplified and the manufacturing time can be reduced.

Referring to FIG. 3, a ratio of the major axis to the minor axis of the sleeve 203 may be 21 to 20, but is not limited thereto. For example, the major axis of the sleeve 203 may be 21 mm and the minor axis may be 20 mm.

The sleeve 203 may be secured to the rear cover 201 by being pressed therein. Therefore, the sleeve according to an exemplary embodiment of the present invention can be more strongly pressed in the rear cover than that of the prior art, and a conventional rear cover and other elements can be utilized.

According to an exemplary embodiment of the present invention, the manufacturing process and the time of installing the rear cover assembly are reduced. In addition, manufacturing costs for the rear cover assembly are reduced.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A rear cover assembly for a drive shaft of an automatic transmission, comprising:
a rear cover to which a bearing for supporting the drive shaft is disposed;
an elliptical sleeve secured to the rear cover; and
a seal ring disposed to the sleeve.

2. The assembly of claim 1, wherein a ratio between a major axis and a minor axis of the sleeve is substantially 21 to 20.

3. The assembly of claim 1, wherein the sleeve is secured to the rear cover by being pressed thereon.

4. A sleeve for a rear cover assembly for a drive shaft of an automatic transmission, comprising a substantially elliptical shape.

5. The sleeve of claim 4, wherein a ratio between a major axis and a minor axis of the sleeve is substantially 21 to 20.

6. The sleeve of claim 4, further configured to be secured to a rear cover by being pressed thereon.
